(19) United States
(12) Patent Application Publication
(10) Pub. No.: US 2018/0202796 A1
(43) Pub. Date: Jul. 19, 2018

(54) MEASURING DEVICE AND METHOD FOR MEASURING AT LEAST ONE LENGTH MEASURAND

(71) Applicant: Carl Mahr Holding GmbH, Goettingen (DE)

(72) Inventor: Rainer Ziegenbein, Rosdorf (DE)

(73) Assignee: Carl Mahr Holding GmbH, Goettingen (DE)

(21) Appl. No.: 15/874,217

(22) Filed: Jan. 18, 2018

(30) Foreign Application Priority Data
Jan. 19, 2017 (DE) 10 2017 100 991.4

(51) Int. Cl. G01B 11/02; G01B 9/02

(52) U.S. Cl. CPC G01B 11/02; G01B 9/02015

(57) ABSTRACT

The invention relates to a measuring device (10) and a method for determining a length measurand of a workpiece. A carrier part (13), on which a probe unit (18) is arranged immovably in a first spatial direction (x), can be moved or positioned by means of a positioning arrangement (12). At least one laser interferometer (24) is connected to the carrier part (13) immovably in the first spatial direction (x). By means of a first laser measuring beam (L1) and a second laser measuring beam (L2), the laser interferometer (24) generates a first measurement signal (S1), which measurement signal describes the distance of the laser interferometer (24) from a first reflector (25) in the first spatial direction (x), and a second measurement signal (S2), which describes the distance of the laser interferometer (24) from a second reflector (26) in the first spatial direction (x). A probe system plane (E), which is immovable in the first spatial direction (x) relative to the carrier part (13) or the probe unit (18) and which extends at right angles to this first spatial direction (x), therefore has a position in the first spatial direction (x) that can be determined by means of the distances of the laser interferometer (24) from the first reflector (25) and the second reflector (26).

### CROSS-REFERENCE TO RELATED APPLICATIONS

This application claims all benefits provided by law including benefit of priority under 35 U.S.C. § 119 to German Patent Application No. 10 2017 100 991.4 filed Jan. 19, 2017, the content of which is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND

### Technical Field of the Invention

The invention relates to a measuring device and a method for measuring at least one length measurand at a workpiece. The measuring device for this purpose has a probe unit which can probe the workpiece with mechanical contact or contactlessly, for example optically, in order to measure the length measurand. For example, outer diameters, inner diameters, contours, etc. of the workpiece can be measured.

### Description of the Prior Art

DE 1588 018 B2 discloses a device for positioning a cross slide. The device works with an optical imaging system in order to determine the position of the cross slide. It is also noted that measuring systems in the form of photoelectric interferometers or photoelectric microscopes are known in order to improve the measurement accuracy.

In the case of interferometric measurement it is necessary to determine the refractive index of the medium, generally air, in which the light beam propagates. To this end, an external high-precision refractometer can be used. However, the measuring beam of the interferometer does not run at the location at which the refractometer measures the refractive index. In addition, the refractive index is not determined synchronously with the length measurement by the interferometer. Since the refractive index is influenced by changing ambient influences, such as air curtains, changing gas constituents of the air, temperature changes, etc., there may be measurement inaccuracies as a result of the fact that the refractive index is not determined synchronously with the measurement of the interferometer and also is performed physically separately from the interferometer measurement.

### SUMMARY

Proceeding from the prior art, the object of the present invention can thus be considered that of creating a measurement device and a method that enable a highly precise length measurement.

This object is achieved by a measurement device having the features of claim 1 and a method having the features of claim 17.

The measuring device has a machine base, on which a carrier part is mounted movably in at least one degree of freedom. The carrier part is preferably movable in at least one linear degree of freedom. A positioning arrangement is designed to move and to position the carrier part in the at least one degree of freedom.

The measuring device additionally has a probe unit, which is arranged on the carrier part. The probe unit is designed to probe a workpiece in order to measure a length measurand. The workpiece can be probed with mechanical contact or contactlessly, in particular optically. A probe unit that probes a workpiece with contact has a probe tip with a probe arm, at the free end of which there sits a probe body or a probe tip for probing the workpiece. An optically probing probe unit has a light emitter and a light receiver which receives the light emitted by the light emitter and reflected at the workpiece.

The carrier part carrying the probe unit defines a probe system plane, of which the position relative to the carrier part is fixed. The probe unit can indeed be arranged on the carrier part movably, for example rotatably or linearly movably, but in such a way that the probe unit cannot be moved relative to the carrier part in a degree of freedom at right angles to the probe system plane. By determining the position of the probe system plane in a degree of freedom at right angles to the extent of the probe system plane, the position of the probe unit and for example of a probe body or a probe tip can in this way be determined for measurement of the length measurand.

The measurement device has at least one interferometer arrangement. Any interferometer arrangement has at least one laser interferometer (double interferometer), a first reflector and a second reflector. The laser interferometer (double interferometer) is designed to emit a first laser measuring beam in a first emission direction towards the first reflector and to emit a second laser measuring beam in a second emission direction towards the second reflector. The first emission direction and the second emission direction are oriented oppositely. The first and the second emission direction are oriented at right angles to the probe system plane.

The first reflector and the second reflector are arranged immovably on the machine base during the measurement when the laser interferometer (double interferometer) is arranged immovably on the carrier part during the measurement, or alternatively also vice versa, so that the laser interferometer (double interferometer) and the reflectors move relative to one another during the measurement in the event of a movement of the carrier part relative to the machine base. The reflectors can be arranged on the machine base for example directly on the machine base or indirectly, in particular by means of a measuring frame. It is possible that the interferometer (double interferometer) and/or the reflectors are not fixedly connected to the carrier part or the machine base, but for adjustment purposes can be moved or adjusted in a controlled manner before or after, but not during measurements.

The laser interferometer (double interferometer) is additionally designed to receive the first laser measuring beam reflected by the first reflector and the second laser measuring beam reflected by the second reflector. The two reflected laser measuring beams, as is known with an interferometer, are superimposed with a reference laser beam and brought to a state of interference. On the basis of the paths traveled by the laser measuring beams, the distance between the laser interferometer and the first reflector and the other distance between the laser interferometer and the second reflector can be determined separately in an evaluation unit. Each of these determined distances also describes the first distance of the probe system plane from the first reflector and the second distance of the probe system plane from the second reflector. The evaluation unit is designed to determine the position of the probe system plane relative to the reflectors and/or relative to the machine base.

The distance between the two reflectors is known. Changing ambient conditions which are detrimental to the measurements can be identified by the redundant information from the measurement with the two laser measuring beams, in particular in real time and moreover at the point at which the measurement by the interferometer is also performed. It is thus possible to take into consideration ambient influences when determining the position of the probe system plane and to perform a correction of the measurement in real time.

The evaluation unit for example can be designed to determine the first distance of the probe system plane from the first reflector and the second distance of the probe system plane from the second reflector. The sum of the first distance and the second distance characterises or corresponds to the known reflective distance between the first reflector and the second reflector. If the distance sum changes, it can thus be concluded that the measurement has been compromised by ambient influences, for example on account of a change in length in the measuring device (drift) and/or on account of an influencing of the light wavelength in the measurement path of the first or second laser measuring beam.

It is additionally possible that the evaluation unit is designed to calculate a corrected first distance and/or a corrected second distance on the basis of the change in the distance sum. If both the corrected first distance and the corrected second distance are calculated, these two corrected values can be used jointly to determine a corrected position of the probe system plane. Errors can thus be further reduced. For example, a middle position, which is located between the position determined by the corrected first distance and the position determined by the corrected second distance, can be determined as corrected position of the probe system plane.

In a preferred embodiment the measuring device has two separate interferometer arrangements. The laser interferometers of the two interferometer arrangements are arranged parallel to the probe system plane at a distance from one another. The two laser interferometers preferably each have the same distance from a central plane running through the probe unit at right angles to the probe system plane. If the distance of the laser interferometers from the central plane is unequal, the difference must be known and it can be taken into consideration accordingly in the correction. The workpiece is probed by the probe unit in this central plane, either with mechanical contact or contactlessly. The central plane corresponds to a virtual Abbe plane so to speak. Although the probe unit does not probe the workpiece over a straight line with the laser measuring beams of the laser interferometers, measurement inaccuracies can be avoided as a result.

By means of a plurality of interferometer arrangements arranged at a distance from one another in a spatial direction and measuring in the same further spatial direction, alignment errors, rotations, tilted positions, etc.—in particular in the slide arrangement—about an axis oriented at right angles to these two spatial directions can additionally be identified.

There can also be just a single interferometer arrangement provided, which is arranged in a central plane running through the probe unit and oriented at right angles to the probe system plane.

The evaluation unit is specified a refractive index value of air, for example as a starting value. This is necessary for the determination of the first distance and/or the second distance, since the light wavelength of the emitted light is dependent on the refractive index and the light wavelength in turn has to be known for the interferometric length measurement. The starting value to be specified for the refractive index value can be determined one time when the machine is initialised during a calibration process. For this purpose, an external refractometer or another device can be used for example, by means of which a refractive index value of air can be determined. The measuring device and the external device are operated for a time. When the measurement signals of the measuring device and the external device change synchronously on account of fluctuations in the ambient conditions, a steady state vibration has been reached. The refractive index value of air determined during this process is specified to the evaluation unit. Changes in the refractive index can be detected by an interferometer arrangement during the operation of the measuring device and can be taken into consideration in the measurement for correction.

The refractive index can be determined again and specified to the evaluation unit when a predefined event occurs, for example when a laser measuring beam is interrupted or changes have been made to the measuring device.

It is additionally advantageous if the provided reflectors are arranged on a measuring frame. The measuring frame is in turn immovably connected to the machine base. The measuring frame can be produced from a material which is insensitive to temperature changes and which can differ from the material of the machine base.

It is additionally advantageous if the positioning device is arranged on the machine base in one or more degrees of freedom with linear guides and/or rotary guides. The measuring frame does not support any forces caused by the measuring device or the workpiece.

In a preferred embodiment the measuring frame can have a first pillar, on which the first reflector is arranged. A second pillar can be provided opposite, on which the second reflector is arranged. For example, the pillars can have a cuboid shape. With a plurality of interferometer arrangements, the measuring frame has a plurality of pillar pairs accordingly, which are each arranged oppositely in pairs. The provided pillars are connected to one another by means of a common baseplate of the measuring frame. The pillars and the baseplate are preferably produced in one piece from a uniform material, preferably without any seams or joints. The reflectors can be applied or screwed to the pillars and/or the baseplate.

For example, mirrors can be used as reflectors. It is thus ensured that the reflected laser measuring beam contacts an accurately determinable point of the laser interferometer, even when there is a large distance between the laser interferometer and the relevant reflector.

In a further preferred embodiment each laser interferometer of an interferometer arrangement can be designed to emit a third laser measuring beam in a third emission direction towards a third reflector and to receive the third laser measuring beam reflected there. The third emission direction is oriented at right angles to the first and the second emission direction, for example in a vertical direction or in a horizontal direction. The laser interferometer of the at least one interferometer arrangement can also be designed to emit a fourth laser measuring beam oppositely to the third emission direction in a fourth emission direction towards a fourth reflector and to receive the third laser measuring beam reflected at the fourth reflector. The position of the probe unit or of the carrier part can thus additionally be determined in a further spatial direction relative to the third and/or fourth reflector or machine base, wherein this further spatial direction is oriented parallel to the probe system plane and/or parallel to the central plane or at right angles thereto. In a development, an embodiment in which six reflectors are provided per interferometer unit and six laser measuring beams are emitted oppositely in pairs in all spatial directions towards respective reflectors is also advantageous.

It is additionally possible to provide at least one interferometer arrangement as described above for each linear degree of freedom in which the probe unit can be moved by means of the positioning device.

### BRIEF DESCRIPTION OF THE FIGURES

Advantageous embodiments of the measuring device of the method will become clear from the dependent claims, the description, and the drawings. Preferred exemplary embodiments will be explained in greater detail hereinafter with reference to the accompanying drawings, in which:

FIG. 1 shows a schematic perspective basic illustration of an exemplary embodiment of a measuring device,

FIG. 2 shows a block diagram-like illustration of the measuring device from FIG. 1,

FIG. 3 shows a block diagram-like illustration of a further exemplary embodiment of a measuring device with two probe units and, according to the example, four interferometer arrangements,

FIG. 4 shows a basic illustration of a laser interferometer as can be used in the measuring devices, and

FIG. 5 shows a basic diagram explaining the determination of a position of a probe system plane relative to two reflectors with use of a laser interferometer.

### DETAILED DESCRIPTION OF PREFERRED EMBODIMENTS

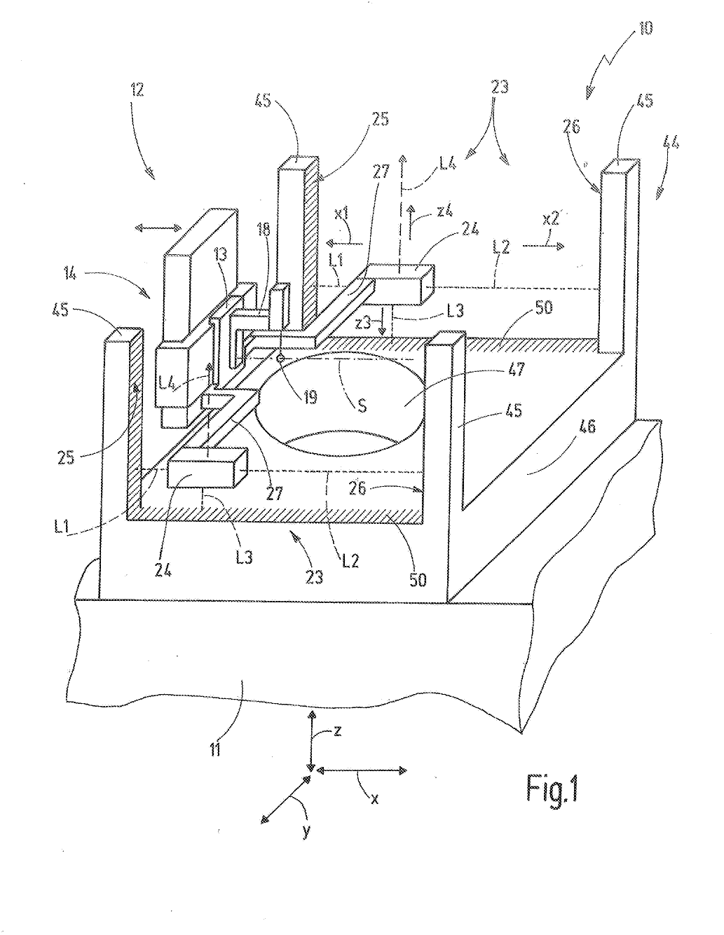

FIGS. 1-3 show exemplary embodiments of a measuring device 10. The measuring device 10 has a machine base 11, which is used to support the measuring device 10 on a substrate surface. The machine base 11 for example can be a machine frame or a cast body.

A positioning arrangement 12 is provided on the machine base 11. The positioning arrangement 12 is used to move and position a carrier part 13 in at least one degree of freedom relative to the machine base 11. The carrier part 13 for example can be moved or positioned relative to the machine base 11 in three linear degrees of freedom by means of a slide arrangement 14. The positioning arrangement 12 for this purpose has corresponding drives. The positioning arrangement 12 can also have rotary guides and drives. The carrier part 13 can be movable in up to six degrees of freedom. The number of the linear degrees of freedom and the rotary degrees of freedom is arbitrary. In the exemplary embodiment illustrated here, the carrier part 13 is movable at least in one first spatial direction x in a linear degree of freedom and optionally also in the other directions y, z in a linear degree of freedom in each case.

A probe unit 18 is arranged on the carrier part 13. The probe unit 18 is used to probe a workpiece (not illustrated) and to measure a length measurand. The probe unit 18 can be formed as a mechanically contacting probe unit 18 or as a probe unit 18 operating contactlessly. In the exemplary embodiments presented here, a probe unit that probes with contact and that has a probe body 19 in the form of a ball tip is shown. The contact of the probe body 19 with a workpiece is identified by the probe unit 18, and the length measurand at the workpiece can be measured on the basis of the position of the probe body 19 relative to a starting position—for example the distance from a calibration plane K oriented at right angles to the probing direction.

The probe unit 18 is arranged on the carrier part 13 immovably in the first spatial direction x. In one exemplary embodiment it can be possible to pivot the probe unit 18 relative to the carrier part 13 about a pivot axis S extending in the first spatial direction x. A linear movability in a second spatial direction y or a third spatial direction z, which are each oriented at right angles to the first spatial direction x, can be provided optionally or alternatively to the pivotability about the pivot axis S.

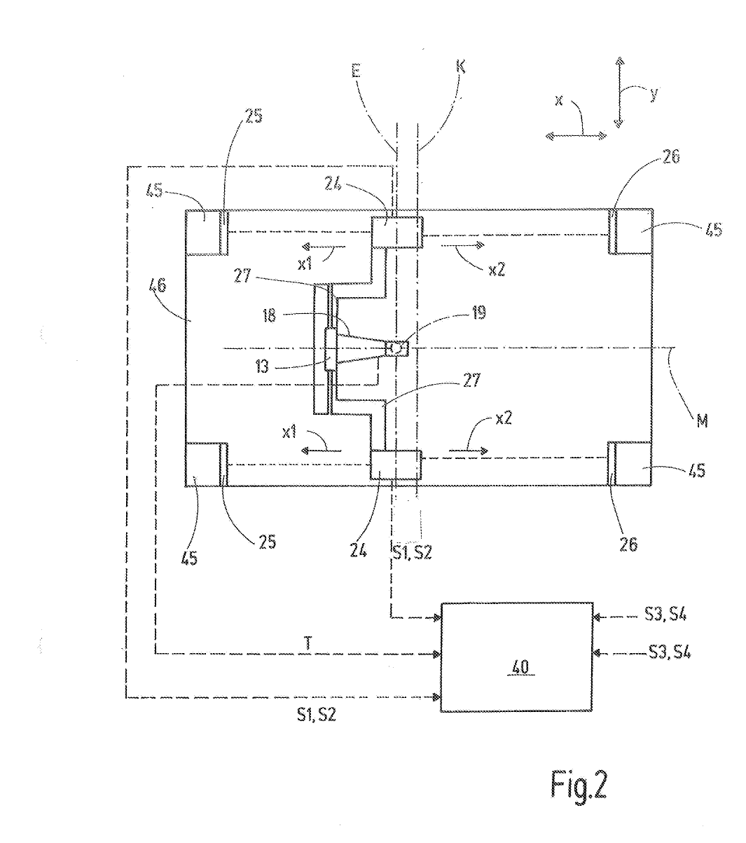

The measuring device 10 additionally includes at least one interferometer arrangement and, in the exemplary embodiment according to FIGS. 1 and 2, two separate interferometer arrangements 23. Each interferometer arrangement 23 includes a laser interferometer 24, a first reflector 25, and a second reflector 26. For example, the reflectors 25, 26 are formed by mirrors. Each laser interferometer 24 is embodied as a double interferometer and thus has two interferometer units. In the exemplary embodiment shown here, each first and second reflector 25, 26 extends parallel to a plane spanned by the second spatial direction y and the third spatial direction z. In each interferometer arrangement 23 the first reflector 25 and the second reflector 26 are arranged oppositely in pairs. The first reflector 25 and the second reflector 26 of an interferometer arrangement 23 are arranged immovably relative to the machine base 11.

The laser interferometer 24 is arranged immovably on the carrier part 13 by means of a holder 27. The relative position of the laser interferometer 24 thus does not change relative to the carrier part 13. The carrier part 13 can be immovable in the second spatial direction y or movable insofar as the laser interferometer 24 remains positioned in a region between the associated first reflector 25 and second reflector 26 and laser measuring beams emitted by the laser interferometer impinge on the reflectors 25, 26. The carrier part 13 is movable in accordance with the example in all spatial directions x, y, z by means of the slide arrangement 12.

The two interferometer arrangements 23 or the two laser interferometers 24 are arranged at a distance from one another in the second spatial direction y. The two laser interferometers 24 are preferably arranged at the same distance from a central plane M, which runs through the probe device 18. The workpiece is preferably probed by the probe device 18 in this central plane M. For example, the probe body 19 is located in the central plane M during the probing operation. The central plane M in the exemplary embodiment extends in a plane spanned by the first spatial direction x and the third spatial direction z.

The carrier part 13 defines a probe system plane E. This probe system plane E is immovable relative to the carrier part 13 and consequently also relative to the probe unit 18 and the at least one laser interferometer 24. The probe system plane E extends at right angles to the central plane M. For example, the probe system plane E can extend through the probe body 19.

Each laser interferometer 24 emits a first laser measuring beam L1 in a first emission direction x1 and a second laser measuring beam L2 in a second emission direction x2. The first emission direction x1 is opposite the second emission direction x2. The two emission directions x1, x2 are oriented parallel to the first spatial direction x.

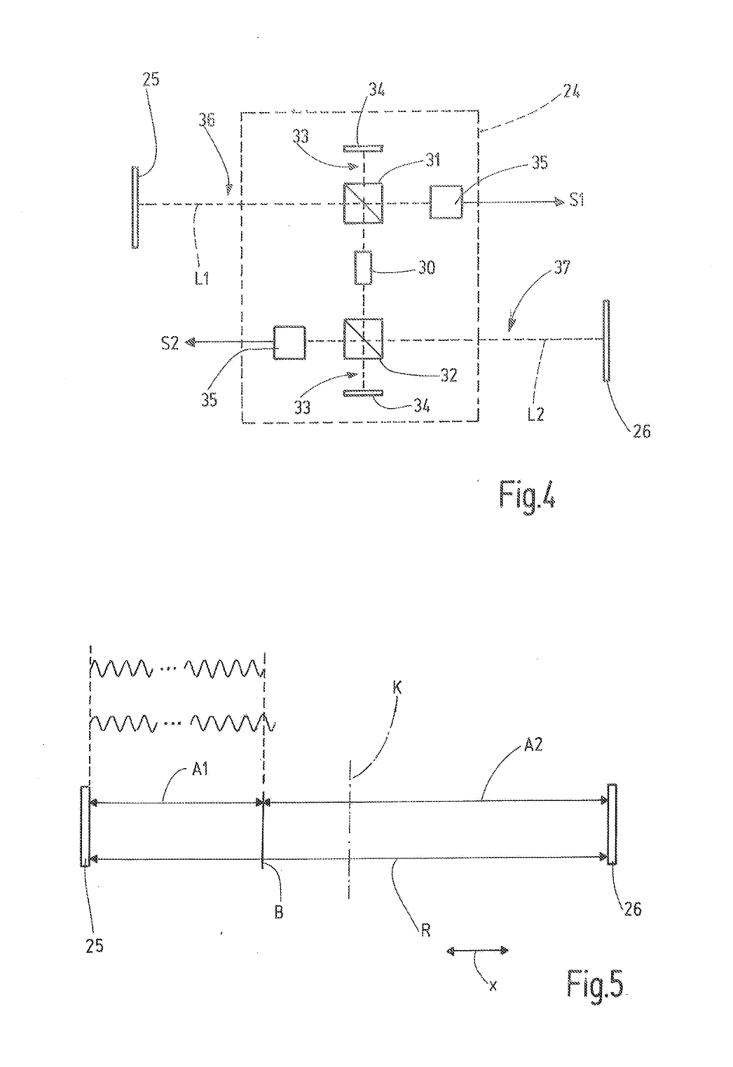

The first laser measuring beam L1 is directed towards the first reflector 25, is reflected there, and is received again by the laser interferometer 24. The second laser measuring beam L2 is directed towards the second reflector 26, is reflected there, and is received by the laser interferometer 24. The schematic structure of a laser interferometer 24 is illustrated in very simplified form in FIG. 4.

A laser source arrangement 30 with at least one laser generates laser light directed towards a first beam splitter 31 and a second beam splitter 32. The first beam splitter 31 splits the incident light into the first laser measuring beam L1, which is output in a first measuring light path 36, and reference laser beam, which is output in a reference light path 33. Similarly, the second beam splitter 32 splits the incident laser light into the second laser measuring beam L2, which is output in a second measuring light path 37, and a reference laser beam output in a further reference light path 33. The reference light paths 33 are each terminated by a mirror 34, which reflects back again the reference laser beam coming from the relevant beam splitter 31, 32.

The first laser measuring beam L1 reflected at the first reflector 25 and the second laser measuring beam L2 reflected at the second reflector 26 are superimposed, respectively, in the first beam splitter 31 and second beam splitter 32 with the reference laser beam originating from the corresponding reference light path 33 and are directed towards a light receiver, for example a camera 35. The superimposition causes constructive and/or destructive interference. The camera 35 can receive the superimposed light originating from the associated beam splitters 31 and 32. Changes in the light path of the first laser measuring beam L1 and the second laser measuring beam L2 can be identified with high accuracy on the basis of the interference.

The laser interferometer 24 illustrated schematically in FIG. 4 can also be referred to as a double interferometer because it has two separate measuring light paths 36, 37. The first measuring light path 36 corresponds to the path of the first laser measuring beam L1 from the laser interferometer 24 to the first reflector 25, and from there back to the laser interferometer 24. The second measuring light path 37 corresponds to the path of the second laser measuring beam L2 from the laser interferometer 24 to the second reflector 26 and back again to the laser interferometer 24.

Each laser interferometer 24 delivers a first measurement signal S1, which describes the distance between the laser interferometer 24 and the first reflector 25, and a second measurement signal S2, which describes the distance of the laser interferometer 24 from the second reflector 26. The first measurement signal S1 and the second measurement signal S2 of each laser interferometer 24 are transmitted to an evaluation unit 40. The evaluation unit 40 additionally transmits the probe signal T generated when the workpiece is probed by the probe unit 18.

In the exemplary embodiment illustrated here, two interferometer arrangements 23 and consequently two first reflectors 25 and two second reflectors 26 are provided. It can be seen in FIG. 1 that the reflectors 25, 26 are not arranged directly on the machine base 11. A measuring frame 44 is arranged immovably on the machine base 11 and in turn carries the provided first reflectors 25 and second reflectors 26. Each of these reflectors 25, 26 is arranged on a pillar 45 of the measuring frame 44. The two pillars 45, which carry a first reflector 25 and a second reflector 26 of a common interferometer arrangement 23, are arranged oppositely in the first spatial direction x at a distance from one another. The pillars 45 extend in the third spatial direction z starting from a common baseplate 46. The four pillars 45 according to the example and the baseplate 46 form the measuring frame 44, which in accordance with the example is produced in one piece from a uniform material, without any seams or joints. The material of the measuring frame 46 can differ from the material of the machine base 11.

The pillars 45 in the exemplary embodiment have a cuboid shape. The first reflector 25 and the second reflector 26 can thus be attached very easily on a cuboid face of the pillar 45 extending in a plane spanned by the second spatial direction y and the third spatial direction z.

The measuring frame 44 is free from loads generated by the measuring device 10 or the workpiece, in particular free from forces and moments generated by the workpiece, by the probe unit 18 or by the positioning arrangement 12 and are supported by the machine base 11. Deformations of the measuring frame caused by external forces are consequently avoided so as not to compromise the measurement accuracy.

A recess 47 can therefore be provided in the measuring frame 44, and in accordance with the example in the baseplate 46, through which recess a workpiece mount, such as a rotatable plate or clamping unit, can protrude without being supported on the measuring frame 44.

The above measuring device 10 according to FIGS. 1 and 2 operates as follows:

In order to be able to determine a length measurand at a workpiece when the workpiece is probed by the probe unit 18, it is necessary to know the position of the probe unit 18. In accordance with the example the workpiece is probed along the first spatial direction x. It is then necessary to determine the position of the probe system plane E in the first spatial direction x, in accordance with the example relative to a calibration plane K. The at least one interferometer arrangement 23 is used for this purpose.

A first distance of the probe system plane E from the first reflector 25 and a second distance A2 of the probe system plane E from the second reflector 26 can be determined in the evaluation unit 40 on the basis of the first measurement signal S1 and the second measurement signal S2. This is because the laser interferometers 23 are connected immovably to the carrier part 13 and therefore are not movable relative to the probe system plane E. The reflector distance R in the first spatial direction x between the first reflector 25 and the second reflector 26 is known. The distance sum of the first distance A1 and the second distance A2 thus characterises or corresponds to the reflector distance R. If this distance sum of the first distance A1 and the second distance A2 changes, the evaluation unit 40 can conclude on this basis that the change has been brought about by ambient influences. Such ambient influences can change one or more lengths of the measuring device 10, for example the orientation of the movement of the slide arrangement in space. The light wavelength can also change as a result of ambient influences, for example if the gas composition of the air changes or density thereof (on account of temperature changes), etc.

Such ambient influences are taken into consideration by the measuring device 10 according to the invention. They are identified in real time and can be used for a correction of the determined position of the probe system plane E in the first spatial direction x in real time.

If the distance sum of the first distance A1 and the second distance A2 changes starting from a calibrated value, this change can be taken into consideration proportionally in the calculation of a corrected first distance and a corrected second distance. If, for example, the distance sum has increased by 0.1%, the measured first distance A1 and the measured second distance A2 can each be reduced by 0.1% in order to obtain the corrected first distance and the corrected second distance.

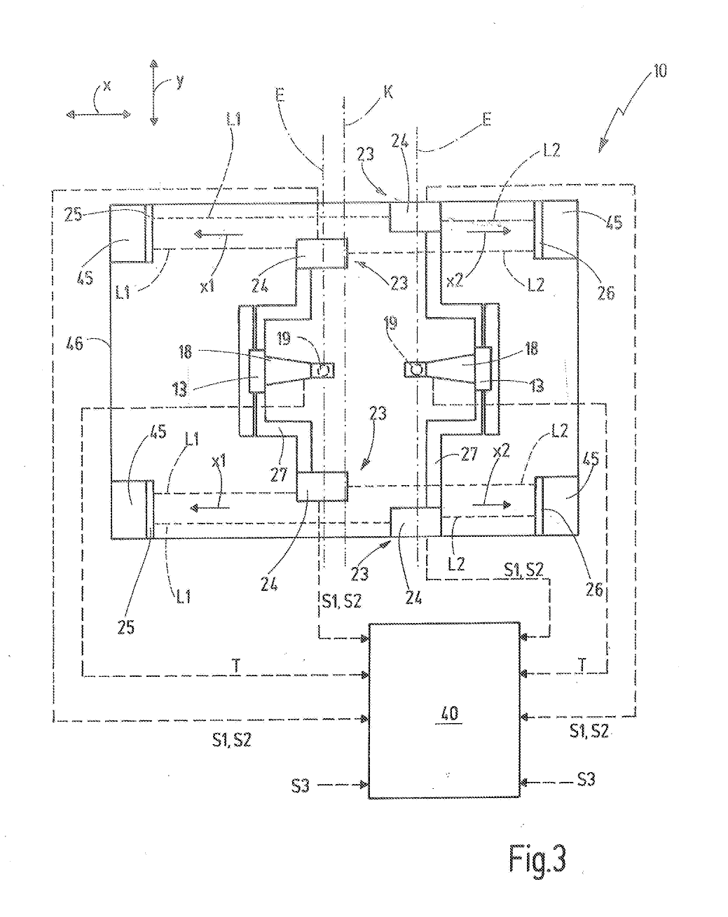

Both the corrected first distance and the corrected second distance can additionally be used in the evaluation unit 40 in order to determine a corrected position of the probe system plane E in the first spatial direction x. This can be implemented by forming an average value or the like. Measurement inaccuracies can thus be further reduced. All available measured values can be used for correction, for example the measurement results by the four laser measuring beams L1, L2 from the embodiment according to FIGS. 1 and 2, or by the eight laser measuring beams L1, L2, L3 from the embodiment according to FIG. 3.

In the exemplary embodiment illustrated in FIGS. 1 and 2, two interferometer arrangements 23 are provided. The position of the probe system plane E is therefore determined spatially separately at two different points, which are each arranged at the same distance from a central plane M. A virtual Abbe plane is thus provided in the central plane M. When the workpiece is probed by the probe unit 18 in the central plane M, a very high accuracy results. Tilting movements of a unit formed of the carrier part 13, holders 27, the laser interferometers 24, and the probe unit 18 about an axis extending in the third spatial direction z are detected and can be taken into consideration when determining the length measurand by means of a corresponding correction in the evaluation unit 40.

When probing a workpiece, various length measurands can be determined, for example an outer diameter or inner diameter of a cylindrical or hollow-cylindrical workpiece, the contour of the surface, etc.

When the measuring device 10 is initialised before being operated for the first time, a highly precise refractometer, a weather station, etc. for example determines the refractive index of the air besides the measuring device 10. However, due to local smear formation or other local influences, the refractive index of the external device does not necessarily have to match the refractive index of the air at the at least one interferometer arrangement 23. During the initialisation, the measuring device 10 and external device are therefore operated until there is a synchronicity in the change of the measurement signals of the at least one interferometer arrangement 23 and the external device. The refractive index determined in this state is specified to the evaluation unit 40 and used during the measurement operation.

The refractive index is thus known at the start of the measurement. All changes in the determined distance sum of the measured first distance A1 and the measured second distance A2 can therefore be attributed to modified ambient conditions. Changes of this kind result fundamentally in a change to the light wavelength in the first measurement path 36 or in the second measurement path 37, which is illustrated in a highly schematic manner in FIG. 5 on the basis of the first distance A1. The ambient-induced change is therefore detected in the interferometer arrangement 23 in real time at the point at which the measurement for determining the position of the probe system plane E is also taken, this being necessary in turn for the measurement of a measured length value by means of the probe unit 18. Errors that result when determining the ambient conditions, in particular the current light wavelength, with a spatial distance from at least one interferometer arrangement 23 are thus avoided. In the exemplary embodiment an ambient-induced measurement influence is determined by each provided interferometer arrangement 23 itself, i.e. directly at the measurement location, so that local differences in the ambient conditions do not have a negative effect on the measurement accuracy.

Following the determination and specification of the refractive index of the calibrated light wavelength, the orientation of the reflectors 25, 26 in space or relative to one another can additionally be determined at the time of initialisation. The first distance A1 and the second distance A2 can be determined at a plurality of points at the first and second reflector 25, 26 of an interferometer arrangement 23. The evaluation unit 40 can thus be specified a reflector distance R at each possible position of the laser interferometer 24 relative to the two reflectors 25, 26 of the relevant interferometer arrangement 23. Design-related changes in the reflector distance R can then also be taken into consideration during later measurements of a workpiece when determining a corrected first distance and/or a corrected second distance and/or a corrected position of the probe system plane E.

A further exemplary embodiment of the measuring device 10 is illustrated schematically in FIG. 3. There, two probe units 18 are arranged in each case on a separate carrier part 13. Each carrier part 13 can be positioned by means of a positioning arrangement 12. At least one laser interferometer, and according to the example two laser interferometer is 24, is/are arranged immovably on each carrier part 13 by means of a holder 27. Each laser interferometer 24, together with an associated first reflector 25 and an associated second reflector 26, forms an interferometer arrangement 23. In this example each first reflector 25 and each second reflector 26 is part of an interferometer arrangement 23 for one of the two probe units 18. A measuring frame 44 with four pillars 45 and a total of four reflectors 25, 26 can thus also be used for the four interferometer arrangements 23 provided in FIG. 3.

In the exemplary embodiment of the measuring device 10 illustrated in FIG. 1, a further optional design possibility is illustrated schematically. Similarly to the above-described arrangement, the measuring principle can be used not only for the first spatial direction x, but also for the third spatial direction z. Each laser interferometer 24 can be designed to direct a third laser measuring beam L3 in a third emission direction z3 towards a third reflector 50 and also to direct a fourth laser measuring beam L4 in a fourth emission direction z4 opposite the third emission direction z3 towards a fourth reflector (not shown). To this end, four laser interferometer units or two double interferometers are provided accordingly in the interferometer arrangement 23. The third and fourth emission direction z3, z4 are oriented parallel to the third spatial direction z in accordance with the example. The third and fourth emission direction z3, z4 are at right angles to the first emission direction x1 and the second emission direction x2. The third reflector 50 is arranged in accordance with the example on the baseplate 46 of the measuring frame 44 and is disposed between the first reflector 25 and the second reflector 26 of the interferometer arrangement 23. For example, the fourth reflector can be arranged on a transverse piece connecting the pillars 45 at a distance from the baseplate 46. In addition to the position of the probe system plane E in the first spatial direction x, a further position value can thus additionally be determined in the third spatial direction z for the carrier part 13 or the probe unit 18. The laser interferometer 24 can generate a corresponding third and fourth measurement signal S3, S4 and can transmit it to the evaluation unit 40 (illustrated optionally in FIGS. 2 and 3). A third or fourth measurement signal S3, S4 of this kind can be generated by each provided laser interferometer 24 of each interferometer arrangement 23 and can be transmitted to the evaluation unit 40.

In a further embodiment each interferometer arrangement 23 can have up to six laser interferometers or three double interferometers so as to measure in one, two or all three spatial directions x, y, z.

Before a measurement is begun, the measuring device 10 can be calibrated to a calibration plane K. The calibration plane K extends in the middle between the first reflector 25 and the second reflector 26 at right angles to the first spatial direction x or parallel to the probe system plane E. If the probe system plane E and the calibration plane K are congruent, the probe unit 18 is then in a starting or zero position. Starting from here, the length measurands of a workpiece can be measured. The calibration plane K extends preferably centrally through a corresponding mount or holder for the workpiece.

The invention relates to a measuring device 10 and a method for determining a length measurand of a workpiece. A carrier part 13, on which a probe unit 18 is arranged immovably in a first spatial direction x, can be moved or positioned by means of a positioning arrangement 12. At least one laser interferometer 24 can be connected immovably in the first spatial direction x to the carrier part 13. In order to form an interferometer arrangement 23, a first reflector 25 and a second reflector 26 are associated with each laser interferometer 24. The two reflectors 25, 26 are arranged oppositely at a distance from one another in the first spatial direction x. The laser interferometer 24, by means of a first laser measuring beam L1 and a second laser measuring beam L2, generates a first measurement signal S1, which describes the distance of the laser interferometer 24 from the first reflector 25 in the first spatial direction x, and a second measurement signal S2, which describes the distance of the laser interferometer 24 from the second reflector 26 in the first spatial direction x. A probe system plane E, which is immovable in the first spatial direction x relative to the carrier part 13 or the probe unit 18 and which extends at right angles to this first spatial direction x, thus has a position in the first spatial direction x which can be determined on the basis of the distances of the laser interferometer 24 from the first reflector 25 and second reflector 26. By means of the provided redundancy, ambient influences on the measurement can be determined in real time and locally at the point at which a measurement is taken by the laser interferometer 24 and can be taken into consideration in the measurement.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

### LIST OF REFERENCE SIGNS

10 measuring device
11 machine base
12 positioning arrangement
13 carrier part
14 slide arrangement
18 probe unit
19 probe body
23 interferometer arrangement
24 laser interferometer
25 first reflector
26 second reflector
27 holder
30 laser source arrangement
31 first beam splitter
32 second beam splitter
33 reference light path
34 mirror
35 camera
36 first measuring light path
37 second measuring light path
40 evaluation unit
44 measuring frame
45 pillar
46 baseplate
47 recess
50 third reflector
E probe system plane
M central plane
K calibration plane
L1 first laser measuring beam
L2 second laser measuring beam
L3 third laser measuring beam
L4 fourth laser measuring beam
S pivot axis
S1 first measurement signal
S2 second measurement signal
S3 third measurement signal
S4 fourth measurement signal
T probe signal
x first spatial direction
x1 first emission direction
x2 second emission direction
y second spatial direction
z third spatial direction
z3 third emission direction
z4 fourth emission direction

What is claimed is:

1. A measuring device (10) for measuring at least one length measurand,
with a machine base (11), on which a carrier part (13) is mounted movably in at least one degree of freedom (x),
with a positioning arrangement (12), which is designed to position the carrier part (13) in the at least one degree of freedom (x),
with a probe unit (18), which is designed to probe a workpiece and which is arranged on the carrier part (13),
wherein the carrier part (13) defines a probe system plane (E), of which the position relative to the carrier part (13) is fixed,
with at least one interferometer arrangement (23), having a laser interferometer (24), which is designed to emit a first laser measuring beam (L1) in a first emission direction (x1) towards a first reflector (25) and to receive the first laser measuring beam (L1) reflected at the first reflector (25), and which is designed to emit a second laser measuring beam (L2) in a second emission direction (x2), which is opposite the first emission direction (x1), towards a second reflector (26) and to receive the second laser measuring beam (L2) reflected at the second reflector (26), wherein the first and the second emission direction (x1, x2) are oriented at right angles to the probe system plane (E),
wherein the first reflector (25) and the second reflector (26) are arranged on the machine base (11) when the laser interferometer (24) is arranged on the carrier part (13), and wherein the first reflector (25) and the second reflector (26) are arranged on the carrier part (13) when the laser interferometer (24) is arranged on the machine base (11),
with an evaluation unit (4), which is designed to determine the position of the probe system plane (E) relative to the reflectors (25, 26) and/or the machine base (11) on the basis of the paths traveled by the laser measuring beams (L1, L2).

2. The measuring device according to claim 1, characterised in that the evaluation unit (40) is designed to detect a change in length of the measuring device (10) and/or a change in wavelength of the laser light in the laser measuring beams (L1, L2) caused by ambient influences and to take this into consideration when determining the position of the probe system plane (E).

3. The measuring device according to claim 2, characterised in that the evaluation unit (40) is designed to detect the change in length of the measuring device (10) and/or the wavelength change of the laser light in the laser measuring beams (L1, L2) in real time and to take this into consideration when determining the position of the probe system plane (E).

4. The measuring device according to any one of claim 1, characterised in that the evaluation unit (40) is designed to determine a first distance (A1) of the probe system plane (E) from the first reflector (25) on the basis of the measurement with the first laser measuring beam (L1) and to determine a second distance of the probe system plane (E) from the second reflector (26) on the basis of the measurement with the second laser measuring beam (L2).

5. The measuring device according to claim 4, characterised in that the evaluation unit (40) is designed, when determining the position of the probe system plane (E), to take into consideration the fact that the distance sum of the first distance (A1) and the second distance (A2) describes the known reflector distance (R) between the first reflector (25) and the second reflector (26) and to identify, on the basis of a change in the distance sum, that a length of the measuring device (10) and/or the light wavelength has changed on account of ambient influences.

6. The measuring device according to claim 5, characterised in that the evaluation unit (40) is designed to calculate a corrected first distance (A1) and/or a corrected second distance (A2) on the basis of the change in the distance sum.

7. The measuring device according to claim 6, characterised in that the evaluation unit (40) is designed to determine a corrected position of the probe system plane (E) from the corrected first distance and/or the corrected second distance.

8. The measuring device according to claim 1, characterised in that two interferometer arrangements (23) are provided, wherein the laser interferometers (24) of the two interferometer arrangements (23) each have the same or a known distance from a central plane (M) which runs through the probe unit (18) and is oriented at right angles to the probe system plane (E).

9. The measuring device according to claim 8, characterised in that the workpiece is probed by means of the probe unit (18) in the central plane (M).

10. The measuring device according to claim 1, characterised in that a single interferometer arrangement (23) is provided, which is arranged in a central plane (M) which runs through the probe unit (18) and is oriented at right angles to the probe system plane (E).

11. The measuring device according to claim 1, characterised in that a refractive index value of air is pre-specified for the evaluation unit (40) as a starting value.

12. The measuring device according to claim 1, characterised in that the provided reflectors (25, 26) are arranged on a measuring frame (44) arranged on the machine base (11).

13. The measuring device according to claim 12, characterised in that the provided reflectors (25, 26) are each arranged on a pillar (45) of the measuring frame (44), which pillars are arranged opposite one another in pairs.

14. The measuring device according to claim 13, characterised in that the pillars (45) are connected to one another by means of a common baseplate (46) of the measuring frame (44).

15. The measuring device according to claim 1, characterised in that the laser interferometer (24) of the at least one interferometer arrangement (23) is designed to emit a third laser measuring beam (L3) towards a third reflector (50) in a third emission direction (z3) oriented at right angles to the first and the second emission direction (x1, x2) and to receive the third laser measuring beam (L3) reflected at the third reflector (50).

16. The measuring device according to claim 15, characterised in that the laser interferometer (24) of the at least one interferometer arrangement (23) is designed to emit a fourth laser measuring beam (L4) towards a fourth reflector in a fourth emission direction (z4) opposite the third emission direction (z3) and to receive the third laser measuring beam (L4) reflected at the fourth reflector.

17. A method for measuring at least one length measurand with use of a measuring device (10) with a machine base (11), on which a carrier part (13) is mounted movably in at least one degree of freedom (x), with a positioning arrangement (12), which is designed to position the carrier part (13) in the at least one degree of freedom (x), with a probe unit (18), which is designed to probe a workpiece and which is arranged on the carrier part (13), wherein the probe unit (18) defines a probe system plane (E), with at least one interferometer arrangement (23), having a laser interferometer (24), a first reflector (25), and a second reflector (26), wherein the reflectors (25, 26) are arranged on the machine base (11) when the laser interferometer (24) is arranged on the carrier part (13) and are arranged on the carrier part (13) when the laser interferometer (24) is arranged on the machine base (11), and with an evaluation unit (40), wherein the method comprises the following steps:
emitting a first laser measuring beam (L1) towards the first reflector (25) in a first emission direction (x1) and receiving the first laser measuring beam (L1) reflected at the first reflector (25),
emitting a second laser measuring beam (L1) towards the second reflector (26) in a second emission direction (x2) opposite the first emission direction (x1) and receiving the second laser measuring beam (L2) reflected at the second reflector (26),
determining the position of the probe system plane (E) relative to the reflectors (25, 26) and/or the machine base (11) on the basis of the paths traveled by the laser measuring beams (L1, L2).

18. The method according to claim 17, characterised in that a starting value for the refractive index of the air in the surroundings of the measuring device (10) is determined and pre-specified to the evaluation unit (40) by means of an external refractometer in an initialisation process of the measuring device (10).
